(19) United States
(12) Patent Application Publication
(10) Pub. No.: US 2007/0136322 A1
(43) Pub. Date: Jun. 14, 2007

(54) System and method for a content history-based electronic guide

(75) Inventors: Christopher Cormack, Hillsboro, OR (US); Tony Moy, Beaverton, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/302,809

(22) Filed: Dec. 13, 2005

(51) Int. Cl. G06F 7/00

(52) U.S. Cl. 707/100

(57) ABSTRACT

A system and method for a content history-based electronic guide. One method includes tracking content accessed by a viewer; updating a history buffer based on the accessed content; and generating a content history-based electronic guide based on content, related guide data and the history buffer.

### BACKGROUND

Standard electronic program guides (EPGs) provide a program listing based on the channel, for given time slots. This is typically a huge list that the viewer must manually search through to find his or her favorite programs. Finding specific programs can be quite difficult as the viewer must scroll down and to the right of the EPG for long periods of time and often through multiple screens of information.

### BRIEF DESCRIPTION OF THE DRAWINGS

The invention may be best understood by referring to the following description and accompanying drawings that are used to illustrate embodiments of the invention. In the drawings:

FIG. 1 illustrates an example of a standard electronic program guide (EPG);

FIG. 2 illustrates an example of a viewer history buffer, according to an embodiment of the invention;

FIG. 3 illustrates an example of a content history-based electronic guide, according to an embodiment of the invention;

FIG. 4 illustrates an embodiment of an environment for the content history-based electronic guide, in which some embodiments of the present invention may operate;

FIG. 5 illustrates an embodiment of an environment for the content history-based electronic guide, in which some embodiments of the present invention may operate; and

FIG. 6 is a flow diagram of one embodiment of a process for the operation of generating a content history-based electronic guide, in which some embodiments of the present invention may operate.

### DESCRIPTION OF EMBODIMENTS

According to an embodiment of the invention, a system and method for a content history-based electronic guide are described. In some embodiments of the invention, the content history-based electronic guide may reflect favorite or most frequently watched content as determined by a history-based electronic guide generator and based on viewer history. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

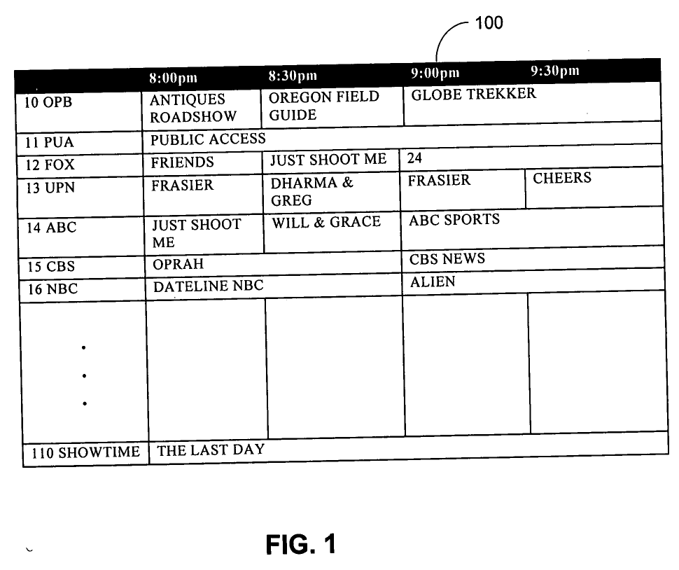

FIG. 1 illustrates an example of a standard electronic program guide (EPG) 100. Referring to FIG. 1, the standard EPG is broadcast channel oriented, for given time slots. This is typically a huge list that the viewer must manually search through to find his or her favorite shows. Finding specific shows can be quite difficult as the viewer must scroll down and to the right of the EPG for long periods of time and often through multiple screens of information to search for favorite shows.

In contrast to a standard EPG, the content history-based electronic guide of the present invention helps a viewer to easily determine how to access his or her favorite or most frequently watched content. In an embodiment of the invention, content may include, but is not limited to, shows or programs, voice, audio, music, graphics, video games, books, and so forth. The content may be broadcasted, pre-recorded and stored on a digital recording device (such as a personal video recorder (PVR)), streamed or downloaded via the Internet, stored on a home local area network (LAN) (such as in a networked home entertainment system), and so forth.

In an embodiment of the invention, a viewer may optionally log into the present invention prior to selecting content to view/download or prior to scheduling content to be recorded. In this manner, the present invention may “learn” the viewer's most frequently watched content over time by maintaining a history buffer for the viewer.

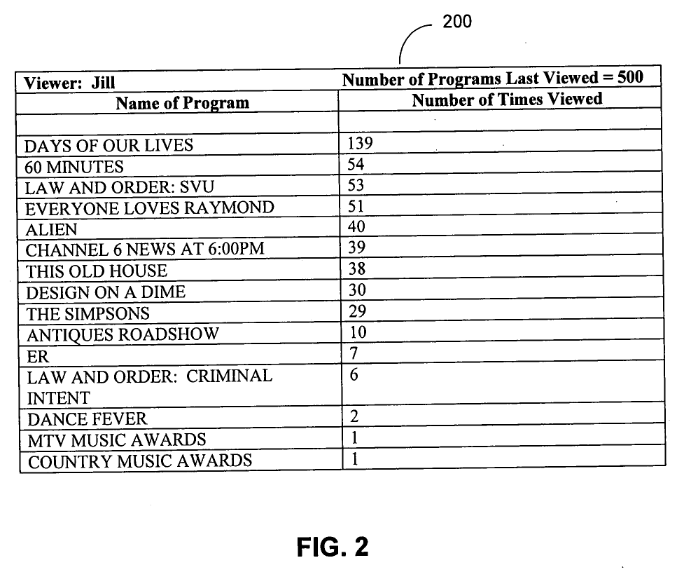

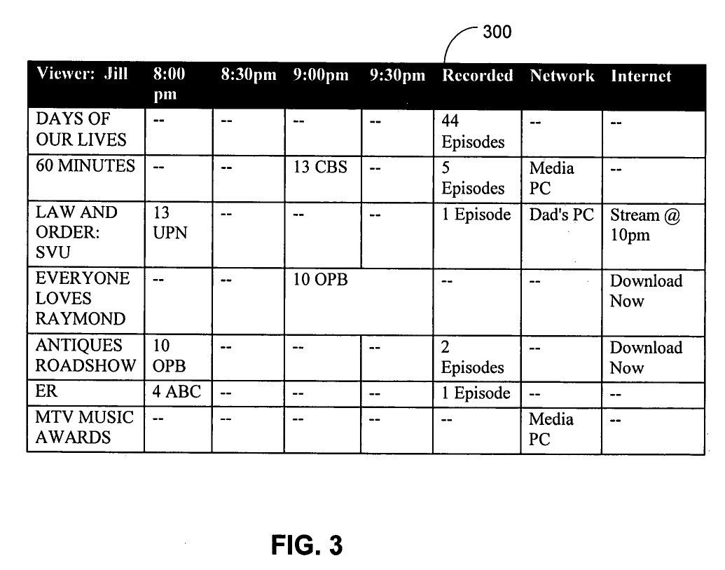

The history buffer may reflect the top n content viewed/downloaded/recorded by the viewer. In an embodiment of the invention, the viewer's history buffer may be used to generate a content history-based electronic guide that lists the viewer's most frequently watched content first, the viewer's next most frequently watched content second, and so forth. An example viewer history buffer is illustrated next with reference to FIG. 2. An example content history-based electronic guide is illustrated below with reference to FIG. 3.

FIG. 2 illustrates an example of a viewer history buffer 200, according to an embodiment of the invention. As described above, the history buffer may reflect the top n content viewed/downloaded/recorded by the viewer. A user interface or remote control button may be utilized by a viewer to allow for easy access and/or modification to his or her history buffer.

In the example history buffer illustrated in FIG. 2, n=500. The value for n may be set at any number. Referring to FIG. 2, a viewer identified as “Jill” has viewed/downloaded/recorded “DAYS OF OUR LIVES” 139 times, “60 MINUTES” 54 times, “LAW AND ORDER: SVU” 53 times, and so forth. Accordingly, “DAYS OF OUR LIVES” is determined to be Jill's favorite or most frequently watched content, “60 MINUTES” is determined to be Jill's next most-watched content, and so forth. The history buffer illustrated in FIG. 2 is provided for illustration purposes only and is not meant to limit the invention.

FIG. 3 illustrates an example content history-based electronic guide 300, according to an embodiment of the invention. Referring to FIG. 3, Jill's history buffer from FIG. 2 was used to generate the electronic guide illustrated in FIG. 3. The content history-based electronic guide lists Jill's most frequently watched content that is currently available to Jill and provides an indication on how the content is available (e.g., scheduled to be broadcasted, pre-recorded and stored on a digital recording device, available for streaming or downloading via the Internet, stored on a home local area network (LAN), and so forth). Referring to the content history-based electronic guide of FIG. 3, Jill can easily determine that her most frequently watched content “DAYS OF OUR LIVES” is only available via previously recorded episodes. Jill's next most frequently watched content “60 MINUTES” is scheduled to be broadcasted at 9:00 pm on 13 CBS, is available via previously recorded episodes and is available on the network. Other of Jill's content that is reflected in her history buffer and is available for viewing include “LAW AND ORDER: SVU”, “EVERYONE LOVES RAYMOND”, “ANTIQUES ROADSHOW”, “ER” and “MTV MUSIC AWARDS”.

The electronic guide of FIG. 3 may be utilized by a viewer to select what content to watch, listen to, play, record, download, etc. The example electronic guide of FIG. 3 is provided for illustration purposes only and is not meant to limit the invention.

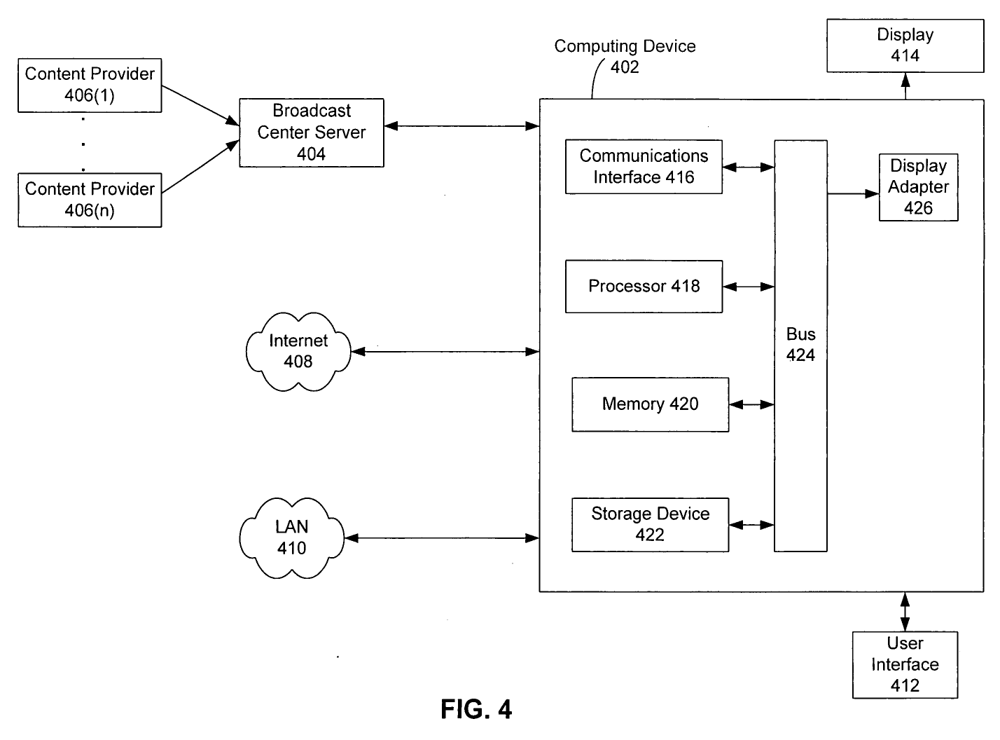

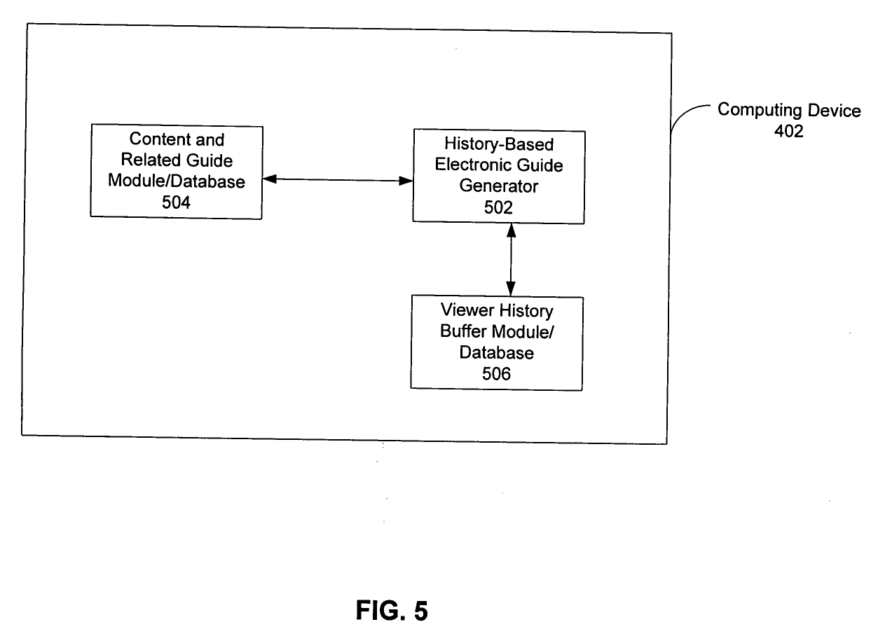

FIGS. 4 and 5 each illustrate an embodiment of an environment for the content history-based electronic guide, in which some embodiments of the present invention may operate. The specific components shown in each of FIGS. 4 and 5 represent one example of a configuration that may be suitable for the invention and is not meant to limit the invention. Thus, other embodiments of the invention may include more or less components as described in each of FIGS. 4 and 5. For example, the functionality of two or more components of FIGS. 4 or 5 may be combined into one component. Likewise, the functionality of one component of FIGS. 4 or 5 may be separated and performed by more than one component. Each component shown in FIGS. 4 or 5 may be implemented as a hardware element, as a software element executed by a processor, as a silicon chip encoded to perform its functionality described herein, or any combination thereof.

The environments of each of FIGS. 4 and 5 may be implemented as a wired communication system, a wireless communication system, or a combination of both. Although the environment of each of FIGS. 4 and 5 may be illustrated using a particular communications medium by way of example, it may be appreciated that the principles and techniques discussed herein may be implemented using any type of communication media and accompanying technology. The embodiments are not limited in this context. Other communication systems may be added or substituted according to the particular application for the environment in FIGS. 4 and 5 and/or as new types of systems are developed.

Referring to FIG. 4, the environment may include, but is not necessarily limited to, a computing device 402, a broadcast center server 404, one or more content providers 406(1)-406(n), the Internet 408, a local area network (LAN) 410, a user interface 412 and a display 414. Computing device 402 may include, but is not necessarily limited to, a communications interface 416, a processor 418, memory 420, a storage device 422, a bus 424 and a display adapter 426. At a high level and in an embodiment of the invention, computing device 402 may receive content and related guide data for a content history-based electronic guide from broadcast center server 404, the Internet 408, LAN 410 and from content stored on computing device 402 itself. Computing device 402 may also receive input via user interface 412 from one or more viewers regarding logging into device 402, activation and/or reconfiguration of the content history-based electronic guide, viewing and/or modification of history buffers, and so forth. The content history-based electronic guide may be displayed on display 414.

In an embodiment of the invention, content may include, but is not necessarily limited to, shows or programs, voice, audio, music, graphics, video games, books, and so forth. In an embodiment of the invention, related guide data may include, but is not necessarily limited to, content name, channel or location (e.g., location on the Internet 408 via an Internet Protocol (IP) address or Uniform Resource Location (URL), location on a hard disk found in LAN 410, location on computing device itself, etc.), type of content (e.g., broadcast, stream, download, etc.), metadata (e.g., content description, year of release, ratings information, category, etc.), air time, a brief synopsis, stars, and so forth. These examples are not meant to limit the invention. Each of the components of FIG. 4 is described next in more detail.

Computing device 402 may be any device adapted to include the functionality of the present invention. For example, device 402 may be a set-top box, a digital video recorder, a digital network recorder, a personal computer, a portable computer, a cellular telephone, a personal digital assistant (PDA), a computing tablet, or any other similar device. Although only one computing device 402 is depicted in FIG. 4, the invention may involve multiple computing devices 402.

In an embodiment of the invention, computing device 402 may include communications interface 416 that allows for the receipt of high-speed digital data such as a cable modem, DSL modem, Ethernet interface, satellite receiver, etc. Computing device 402 may also include a non-volatile storage device 422 for storing received digital data for later access. Such storage devices typically include magnetic media such as hard disk drives and may include other machine readable media such as optical disks, card and stick memory devices, flash memory devices, and the like.

In one embodiment, the invention is included in computing device 402 as software that is stored on storage device 422 or other machine readable medium and is executed by processor 418 which utilizes memory 420. Processor 418 may be any processor, and memory 420 may be any kind of random access memory (RAM) or other form of memory.

Computing device 402 may process received content and related guide data to create a content history-based electronic guide and sends a resulting signal via display adapter 426 to display 414 to be presented to a viewer. Communications interface 416, processor 418, memory 420, storage device 422 and display adapter 426 are, in one embodiment, coupled to bus 424. In various embodiments, computing device 402 may include multiple communications interfaces, processors, storage devices, display adapters and buses, as well as other components not shown in FIG. 4. In various embodiments, computing device 402 may include an audio processor and/or game processor or game interface.

In an embodiment of the invention, computing device 402 may receive content and related guide data for a content history-based electronic guide from broadcast center server 404, the Internet 408 and LAN 410. Content and related guide data used for the history-based electronic guide may also be recorded on computing device 402 itself (e.g., in storage device 422). Broadcast center server 404 may receive data from at least one content provider 406 and forwards digital data to computing device 402. Content providers 406 may be a server computer or a group, subnetwork, LAN or other group of multiple computers, that provide data to broadcast center server 404.

The Internet 408 may be used by computing device 402 for streamed content and related guide data (such as via subscription services) and for downloadable content and related guide data (such as video/audio from an Internet-based store that allows a user to purchase video/audio). LAN 410 may be a household, office, or store media server or personal computers that contain content, such as, for example, television programs and audio files.

In embodiments of the invention, connections between content providers 406, broadcast center server 404, the Internet 408, LAN 410 and computing device 402 may be one or more of T1 lines, T3 lines, coaxial cable, Ethernet, twisted-pair, fiber optics such as a Synchronous Optical Network (SONET), digital television (DTV), cable television (CATV), microwave, satellite, radio waves, or any combination of wired/wireless communications.

In an embodiment of the invention, broadcast center server 404, the Internet 408 and LAN 410 may receive content as digital data or analog data. If analog data is received, it may be converted into an appropriate digital format before being forwarded to computing device 402. When content is received as analog data, it may be any well-known or proprietary analog format, such as the National Television System Committee (NTSC) format.

The format of the content sent to computer device 402 may be any digital data format, including, for example, data interchange formats such as Internet Protocol (IP) Packets and File Transfer Protocol (FTP) packets; combined audio and moving video formats such as the formats promulgated by the International Telecommunications Union (ITU), the Advanced Television Systems Committee (ATSC), and similar organizations such as High Definition Television (HDTV) and Moving Pictures Expert Group (MPEG); related audio formats; still video formats such as Joint Photographic Experts Group (JPEG) format, Graphic Interchange Format (GIF); and so forth.

In an embodiment of the invention, the content history-based electronic guide may be displayed on display 414. Display 414 may be external to computing device 402 or may be incorporated into device 402. Display 414 may be a cathode ray tube (CRT) display monitor, a thin film transistor (TFT) display screen, a liquid crystal display (LCD), or any display device suitable for displaying graphics and images.

User interface 412 may be any device capable of allowing one or more viewers to interface with computing device 402. User interface 412 may be external to computing device 402 or may be incorporated into device 402. For example, user interface 412 may be utilized by one or more viewers to log into computing device 402, to activate the content history-based electronic guide, to configure the content history-based electronic guide, to view and/or modify history buffers, and so forth. In embodiments of the invention, user interface 412 may be implemented as a remote control, a PDA, a touch screen or button(s) on the display 414 or computing device 402, a joystick, a keyboard, a game pad, a personal computer, a laptop computer, a cellular phone, and so forth. These examples are provided for illustration purposes only and are not meant to limit the invention.

FIG. 5 illustrates an embodiment of an environment for the content history-based electronic guide, in which some embodiments of the present invention may operate. Referring to FIG. 5, computing device 402 may include a history-based electronic guide generator 502, a content and related guide module/database 504 and a viewer history buffer module/database 506. Each of these components may be implemented via software, firmware, hardware, or by any combination of various techniques. Each of these components is described next in more detail.

Content and related guide module/database 504 stores, aggregates and indexes the content and related guide data received via broadcast center server 404, the Internet 408, LAN 410 and recorded on computing device 402 itself.

In an embodiment of the invention, viewer history buffer module/database 506 compiles and stores a history buffer for each viewer that logs into computing device 402. Module/database 506 tracks the content that is viewed/downloaded/recorded by each viewer. Here, it is possible to assign multiple viewers per program, such as when an entire family watches the program. If no viewer logs into computing device 402, then it is possible for module/database 506 to compile and store a history buffer for everyone as a group. In this manner, the present invention may “learn” the viewer's favorite or most frequently watched content over time by maintaining a history buffer for the viewer. The history buffer for each viewer may reflect the top n content viewed/downloaded/recorded by the viewer. Note that viewer history buffer module/database 506 may also set a time threshold such that content must be viewed/downloaded/scheduled for a period of time before it is reflected in a history buffer. Here, for example, if a viewer is simply channel-surfing, then the shows that are quickly flipped through may not be saved in the viewer's history buffer. This helps to gather the content that the viewer is really watching in order to obtain more useful viewer behavior. This example is not meant to limit the invention and is provided for illustration purposes only.

History-based electronic guide generator 502 examines the content and/or related guide data from module/database 504 and a viewer history buffer from module/database 506 and generates a content history-based electronic guide.

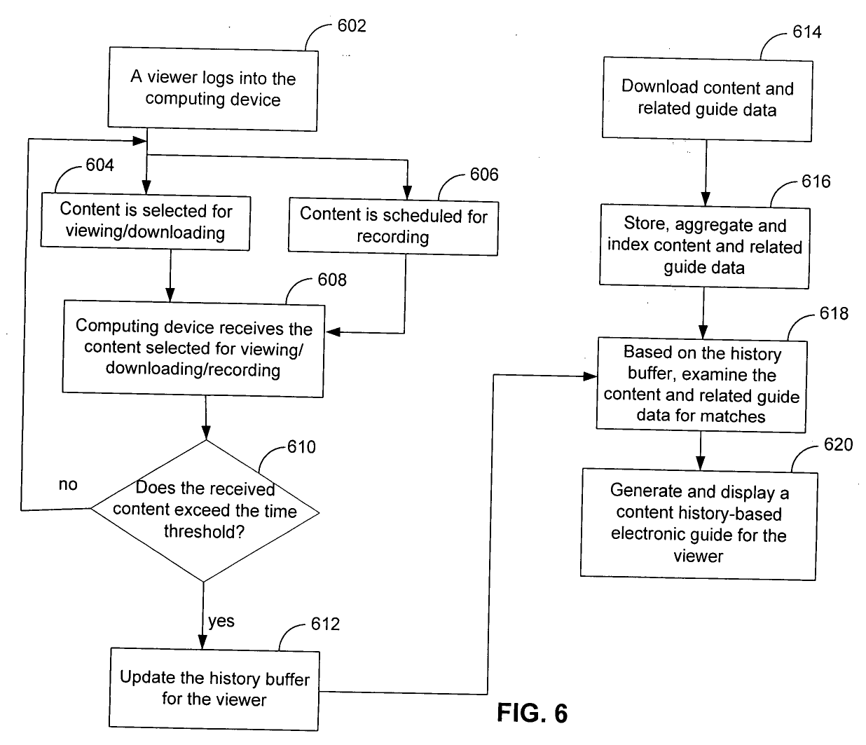

Embodiments of the operation of the present invention are described next with reference to FIG. 6. The flow diagram and other descriptions of processes herein are not intended to imply a fixed order of performing the process stages. Rather, the process stages may be performed in any order that is practicable.

FIG. 6 is a flow diagram of one embodiment of a process for the operation of generating a content history-based electronic guide, in which some embodiments of the present invention may operate. Referring to FIG. 6, the process begins at block 602 where a viewer optionally logs into computing device 402. In other embodiments of the invention, multiple viewers log into computing device 402 for the same program(s), such as when an entire family watches the same program(s). In another embodiment of the invention, if no viewer logs into computing device 402, then it is possible for module/database 506 to compile and store a history buffer for everyone as a group.

The viewer may select content for viewing/downloading, at block 604. The viewer may also schedule content to be recorded, at block 606. In embodiments of the invention, a regular EPG or a content history-based electronic guide may be utilized by a viewer to select what content to view, listen to, play, record, download, etc.

At block 608, computing device 402 receives the content selected for viewing/downloading/recording. It is determined whether the received content exceeds a time threshold, at block 610. If the time threshold is not exceeded, then the process returns to blocks 604/606. If the time threshold is exceeded, then the viewer's history buffer is updated to reflect the received content, at block 612.

At block 614, content and related guide data are downloaded to computing device 402. In embodiments of the invention, computing device 402 may receive content and related guide data from broadcast center server 404, the Internet 408 and LAN 410. At block 616, the content and related guide data are stored, aggregated and indexed via content and related guide module/database 504.

The content, related guide data and viewer history buffer are examined via history-based electronic guide generator 502 for one or more content matches, at block 618. A content history-based electronic guide is generated and displayed, at block 620. In an embodiment, the content of the history-based electronic guide is sorted and displayed, listing the viewer's most frequently watched content first, the viewer's next most frequently watched content second, and so forth. These examples are provided for illustration purposes and are not meant to limit the invention.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc-Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
generating a content history-based electronic guide based on content, related guide data and a history buffer.

2. The method of claim 1, further comprising:
tracking content accessed by a viewer; and
updating the history buffer based on the accessed content.

3. The method of claim 2, wherein the accessed content is one or more of viewed content, downloaded content and recorded content by the viewer.

4. The method of claim 2, wherein the accessed content is only used to update the history buffer if the accessed content exceeds a time threshold.

5. The method of claim 2, wherein the history buffer lists the n most frequently watched content for the viewer.

6. The method of claim 5, further comprising:
displaying the content history-based electronic guide, wherein the displayed content history-based electronic guide lists the viewer's most frequently watched content first, the viewer's next most frequently watched content second, and so forth.

7. The method of claim 2, further comprising:
allowing the viewer to modify the history buffer.

8. The method of claim 1, further comprising: receiving the content, the related guide data and the history buffer at a device, wherein the device generates the content history-based electronic guide.

9. The method of claim 8, wherein the content and the related guide data may be received from one or more of a broadcast center server, the Internet, a local area network (LAN) and the device.

10. The method of claim 8, wherein the device is a set-top box.

11. A system comprising:
a device to generate a content history-based electronic guide based on content, related guide data and a history buffer.

12. The system of claim 11, wherein the device to track content accessed by a viewer and wherein the device to update the history buffer based on the accessed content.

13. The system of claim 12, wherein the accessed content is one or more of viewed content, downloaded content and recorded content by the viewer.

14. The system of claim 12, wherein the accessed content is only used to update the history buffer if the accessed content exceeds a time threshold.

15. The system of claim 12, wherein the history buffer lists the n most frequently watched content for the viewer.

16. The system of claim 15, further comprising:
a display device to display the content history-based electronic guide, wherein the displayed content history-based electronic guide lists the viewer's most frequently watched content first, the viewer's next most frequently watched content second, and so forth.

17. The system of claim 12, further comprising:
a user interface to allow the viewer to modify the history buffer.

18. The system of claim 11, wherein the content and the related guide data may be received from one or more of a broadcast center server, the Internet, a local area network (LAN) and the device.

19. The system of claim 11, wherein the device is a set-top box.

20. A machine-readable medium containing instructions which, when executed by a processing system, cause the processing system to perform a method, the method comprising:
generating a content history-based electronic guide based on content, related guide data and a history buffer.

21. The machine-readable medium of claim 20, further comprising:
tracking content accessed by a viewer; and
updating the history buffer based on the accessed content.

22. The machine-readable medium of claim 21, wherein the accessed content is one or more of viewed content, downloaded content and recorded content by the viewer.

23. The machine-readable medium of claim 21, wherein the accessed content is only used to update the history buffer if the accessed content exceeds a time threshold.

24. The machine-readable medium of claim 21, wherein the history buffer lists the n most frequently watched content for the viewer.

25. The machine-readable medium of claim 24, further comprising:
displaying the content history-based electronic guide, wherein the displayed content history-based electronic guide lists the viewer's most frequently watched content first, the viewer's next most frequently watched content second, and so forth.

26. The machine-readable medium of claim 21, further comprising:
allowing the viewer to modify the history buffer.

27. The machine-readable medium of claim 20, further comprising: receiving the content, the related guide data and the history buffer at a device, wherein the device generates the content history-based electronic guide.

28. The machine-readable medium of claim 27, wherein the content and the related guide data may be received from one or more of a broadcast center server, the Internet, a local area network (LAN) and the device.

29. The machine-readable medium of claim 27, wherein the device is a set-top box.
